(19) United States
(12) Patent Application Publication
(10) Pub. No.: US 2002/0152191 A1
(43) Pub. Date: Oct. 17, 2002

(54) Method of interrogating a database using a quantum computer

(76) Inventors: Lloyd Christopher Leonard Hollenberg, Northcote (AU); Sean Ignatius O'Donoghue, Heidelberg (DE)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 09/790,722

(22) Filed: Feb. 23, 2001

(51) Int. Cl. G06F 7/00

(52) U.S. Cl. 707/1

(57) ABSTRACT

According to a general aspect, the use of a quantum computer for storing a database comprising a plurality of records and searching said database for a record matching a query record, especially a record identical or similar to a query record is disclosed. The database may contain biological data; genetic data; genetic patterns, such as regular expressions, sequence profiles or hidden Markov models; or other data of interest to the user. A genetic sequence; a partial genetic sequence; or other search string may be used to query the database.

This invention generally relates to the field of establishing and searching databases, more specifically databases in the field of biology, especially databases about genetic sequences. The invention also relates to a new use of a quantum computer.

A basic problem in bioinformatics is the matching of sequences. More specifically, having a newly determined DNA or protein sequence, one wishes to know whether this or a similar sequence has already been determined or described previously. Thus, it is necessary to find identical or closely resembling sequences stored in a database. These matching sequences often give an immediate insight into the function of the novel sequence, Matching sequences is a non-trivial task due to the large number of data a sequence usually consists of and due to the large number of sequences already stored in databases. Speed of the searching algorithm is therefore an important issue besides the ability to establish matches between sequences which are only similar or which only have similar parts, For example, a sequence to be matched may consist of a plurality of partial sequences which partial sequences are, however, not contained in a consecutive order in the matching sequence, but are interrupted by other partial sequences which do not have a counterpart in the sequence to be matched. There have been proposed many search algorithms, The best known are the Smith-Waterman dynamic programming algorithm (T. F. Smith and M. S. Waterman, J. Mol. Biol. 147 (1981), 195) or the BLAST algorithm (S. F. Altschul et al., Nucleic Acid Res. 25 (1997), 3989), Whereas the Smith-Waterman algorithm is rather accurate, it is also rather slow and requires a computing time of the order of O(N²), wherein N is the typical number of residues to be compared. The BLAST algorithm requires a computing time that is of the order O (2N) and is thus much faster than the Smith-Waterman algorithm, However, besides requiring relatively expensive computer resources, this algorithm determines only a local alignment and not a global alignment, thereby giving only an approximation to the match of the sequences.

A closely related problem is family matching, where a new sequence is classified into one of the previously established sequence families. Two methods are generally used for this purpose, namely sequence profile methods, such as the PSI-BLAST algorithm (S. F. Altschul et al., Nucleic Acid Res. 25 (1997), 3989), and hidden Markov methods, such as PFAM (A. E. Bateman, Nucleid Acid Res. 28 (2000), 263). These methods reduce the problem rather than matching a new sequence to all previously determined sequences. The new sequence is matched to a smaller subset of sequence families. In practice, these methods are rather similar to sequence matching, One still searches a database with a query sequence. The database of known protein families is also increasing rapidly and the computer resources required are still expensive.

A further related problem is threading, where a new sequence is classified into one of the previously established 3D structural families. These methods differ from the above-mentioned sequence family matching only in that information about the protein 3D structure is generally used) cf. e.g. M. J. Sippl, Current Opinion in Structural Biology 5 (1995), 229. Yet another problem in bioinformatics is sore matching, where two protein structures with different sequences are superimposed. In addition to finding the optimal sequence alignment, one also has to find the optimal 3D structural superposition. As one would expect, the problems one has with “simple” sequence matching increase greatly when moving to multi-dimensional matching. Both the threading problem and the structure matching problem suffer a combinatorial “explosion” due to the higher dimensionality.

From the presently known algorithms it appears that there are intrinsic limits on the speed of the search algorithms on common computers in that an exact algorithm for the global alignment of two sequences will always scale with O(N²) and that accordingly a faster alignment can only be achieved by using a less accurate algorithm. Although computer speed has drastically increased over the years, it is almost a law of computer science that the increase in the amount of data to be handled always keeps up with the increase in computer speed and frequently is even greater.

The invention proposes a new way of handling and implementing a database which is based on the principle of a quantum computer and inherently capable of much more rapid processing as any classical computer, A general outline of the principle of quantum computers is given in A. Steane, “Quantum Computing”, Reports on Progress in Physics 61 (1998), 117.

In a nutshell, quantum mechanics is deterministic in that there are quantum states evolving according to deterministic laws. These states are, however, such that a physical quantity measured in the system may not have and usually has not one single value in this state, but has a plurality of values that can occur with a certain probability. The stochastic distribution of these values is determined by the quantum state and one may say that the classical case where a physical quantity always has only one single value in a physical state is the asymptotic case where this distribution approaches a δ-function. The quantum mechanical principle that a state of a physical system can consist in a superposition of physical states of the system in principle opens the door to highly parallel processing by assigning data to a physical state of the quantum system and by processing a linear combination of these data states. It has been shown (David P. Divincenzo, Phys. Rev. A 51 (1995)), 1015 that any mathematical operation that can be performed in a classical computer can be executed on a quantum computer using so-called qubits, i.e. elementary two-state systems, together with universal logic gates, namely a CNOT gate concatenating two qubits and a gate inversing the state of the qubit. The basic feasibility of establishing quantum logic gates as the basic elements of a quantum computer has meanwhile demonstrated several times, see, for example, J. I. Cirac, P. Zoller, Phys. Rev. Lett. 74 (1995), 4091, C. Monroe et al., Phys. Rev. Lett. 75 (1995), 4714, D. G. Cory et al., Proc. Natl. Acad. Sci. USA 94 (1994), 1634, N. A Gershenfeld and I. L. Chuang, Science 275 (1997), 350.

In considering a search in a database implemented on a quantum computer, there is the problem of singling out one single quantum state (or a plurality of quantum states) corresponding to the search query, when the database is represented as a linear combination of quantum states. L. K. Grover, Phys. Rev. Lett 79 (1997), 325 proposed an abstract quantum algorithm wherein a function (corresponding to an operator having the quantum states as eigenstates) has a value of 1 for one state, said unction having a value of 0 otherwise. He showed that this state can be singled out with a number of steps of order O (N^{½}). Whereas this paper demonstrates the basic feasibility of a search for zeros of a function faster tan by classic algorithms, it does not lend itself immediately to a useful application, as it does not teach how to express a query for a certain record according to predetermined matching criteria and to search for a match. This invention addresses the issue of embodying the query in a fashion such that the Grover algorithm can be applied to common search problems, especially search problems encountered in biological applications. Especially the invention encompasses the definition of a distance function, which may, for example, be similar to the classic Hamming distance, and providing an interaction with the storage medium incorporating this distance.

According to a general aspect the invention provides for the use of a quantum computer for storing a database comprising a plurality of records and searching said database for a record matching a query record, especially a record identical or similar to a query record.

The invention may provide that the database comprises biological data.

The invention may provide that the database comprises genetic data.

The invention may provide that said query comprises a genetic sequence or a partial genetic sequence.

The invention may provide that said databases include genetic patterns, such as regular expressions, sequence profiles or hidden Markov models.

The invention may especially provide that said databases include three-dimensional structure of proteins and/or other macromolecules. The invention may provide that the query record relates to a sequence and the record to be matched relates to a sequence family (“sequence to sequence family matching”). The invention may also provide that the query record relates to a sequence and said record matching said query relates to a structure or a structure family for proteins and/or other macromolecules. The invention may also provide that the query record relates to a structure of a protein and/or another macromolecule and the record to be matched relates to a structure of a protein and/or another macromolecule. One may also contemplate to have the records in said database relating to patents or other documents on sequences which are to be searched for sequences and/or structures of macromolecules.

According to a further aspect the invention relates to a method of performing a search in a database according to a given query, wherein said database is stored on a quantum computer having a storage medium able to assume a plurality of quantum states, said quantum states corresponding to a basis of a storage space, said storage space being a finite or infinite vector space, said quantum computer further comprising means for physically interacting with said storage medium such that the state thereof changes according to a predetermined operation, wherein the records in said database are implemented as record states forming quantum states in said storage space and the database to be interrogated is implemented as a database state of said storage medium, said database state forming a linear combination of the related record states, said method comprising the steps of:

defining a query state as a quantum state of said storage space,

defining a global evaluation state as a linear combination of basic evaluation states, said basic evaluation states having a one-to-one relation to the record states forming the database state,

defining a evolving operator, especially a unitary evolving operator, depending on the query and data stored as records such that the application of said evolving operator on said global evaluation state enhances the amplitude of a basic evaluation state corresponding to a data state identical or similar to the query state,

establishing said global evaluation state in said storage medium,

providing a physical interaction of said interacting means with the part of said storage medium being in the global evaluation state corresponding to said evolving operator,

determining the state or the states of which the amplitude was enhanced, and determining the records corresponding to these states.

The invention may provide that records in said storage medium are implemented in a manner that each record corresponds to a record space, said record space forming a subspace of said storage space spanned by one or more basic vectors, record spaces corresponding to different records being mutually orthogonal in that the basic states of one record space are orthogonal to all basic states of another record space.

For the purpose of this application, a Hilbert space is considered as an infinite dimensional vector space.

The invention may provide that said interacting means apply a magnetic and/or electric field to said storage medium.

Said interacting means may especially apply a magnetic and/or electric field that is varying in space and/or time.

The invention may provide that said evolving operator leaves the space spanned by the basic evaluation states invariant.

In other words, application of said evolving operator leads to a quantum state that is a linear combination of the basic evaluation states the global evaluation state was made of, however, with different amplitudes of the various database states. For the sake of clarity, it should be mentioned that this amplitude could also be 0.

Said evolving operator, especially said unitary evolving operator, may itself be a function of an operator, e.g. a power series, an exponential function, a polynomial or another algebraic function, just to mention a few possibilities.

The invention may provide that said evolving operator, especially said unitary evolving operator, depends on a distance function defined between the query state and the individual record states.

The invention may provide that said distance function is defined through a distance operator acting on the space spanned by said basic evaluation states, said distance operator leaving said basic evaluation states invariant.

The invention may provide that said data states are eigenstates of said distance operator.

The invention may provide that said distance function is a Hamming distance.

The invention may provide that said basic evaluation states comprise qubits indicating said distance of the related record to the query state.

The invention may provide that said basic evaluation states comprise qubits forming an index relating the basic evaluation states to the record states.

Likeweise, the record states may comprise qubits indicating that same index.

The invention may provide that said basic evaluation states are related to said record states by a CNOT operation depending on the query state.

The invention may provide that said query state, said record states and said basic evaluation states are defined by qubits, said basic evaluation states comprise qubits having a state coresponding to 1, if the state of the corresponding qubit of the record state is not identical to the state of a corresponding qubit of the query state, and having a state coresponding to 0, if the state of the corresponding qubit of the record state is identical to the state of a corrseponding qubit of the query state.

The invention may provide that said evaluation state is identical to the database state.

The invention may provide that said evolving operator is identical to or a function of an operator U_{G}, said operator being defined by

U_{G}=−I_{H}I_{S}, wherein

I_{H}=1−|Ψ_{H}><Ψ_{H}|,

Ψ_{H} being the global evaluation state and wherein I_{S} is defined such that

I_{S}|φᵢ>=−|φᵢ>, if Tᵢ is less than a predetermined value,

I_{S}|φᵢ>=|φᵢ>otherwise,

wherein |φᵢ> denotes one of said basic evaluation states and Tᵢ is the distance between the query state and the record state corresponding to |φᵢ>.

The invention may provide that said predetermined value of said distance is essentially 0.

The invention may provide that the step of determining whether the amplitude of one or more basic evaluation states was enhanced to a value close to or equal 1.

The invention may provide the step of determining whether the value of the distance in said state resulting from applying said evolving operator, especially said unitary evolving operator, on said global evaluation state is less than a predetermined value.

The invention may provide comprising the step of determining whether the value of the distance in said state resulting from applying said evolving operator, especially said unitary evolving operator, is essentially zero.

The invention may provide that in a first iteration a first value of said distance for comparing Tᵢ in the definition of I_{S} is given a first value and it is determined whether the value of the distance in said state resulting from applying said evolving operator, especially said unitary evolving operator, is less than said first value, and in a subsequent iteration a second value of said distance for comparing Tᵢ in the definition of I_{S} is determined, said second value being greater than said first value and it is determined whether the value of the distance in said state resulting from applying said evolving operator, especially said unitary evolving operator, is less than said second value.

### BRIEF DESCRIPTION OF THE DRAWINGS

FIG. 1 provides a general sketch of an implementation of a quantum computer.

FIG. 2 schematically illustrates a quantum sequence matching algorithm according to the invention.

The invention will be further illustrated by discussing a simple, non-limiting example of matching a genetic sequence to sequences stored in a database. It should be understood that the invention can be implemented in various other ways and for other purposes that are obvious to people skilled in the art.

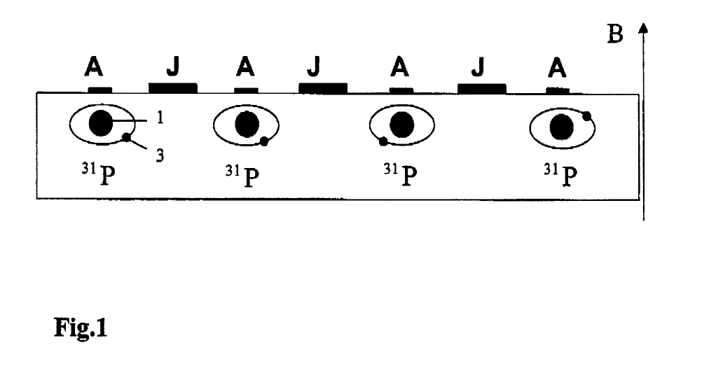

First, a storage medium is provided which has a number of quantum states defined by so-called qubits, i.e. localised two-state systems, said quantum states to be potentially assigned to data. A certain number of these quantum states are assigned to the data to be stored in the database. For example, one may consider a system of localized spins, e.g. nuclear spins as used in NMR or the spin of single electrons trapped in quantum dots. A specific implementation of such a storage medium according to B. E. Kane, Nature 393 (1998), 133 is illustrated in FIG. 1. The qubits of the computer are the nuclear spins 1 of phosphorous atoms which are embedded in a silicon substrate. Individual qubits are coupled via the electrons 3 and controlled externally by voltage gates A and J and magnetic fields (B).

For the purpose of this example, the assignment of data to quantum states is made such that the entire space of states of the storage medium is partitioned into record spaces, each comprising one or more basic quantum states and each basic state in said record space being orthogonal to basic states of other record spaces. This is similar to the classic concept of partitioning a hard disc into certain fields wherein data may be written or from which data may be read out. Usually, one will define such a record space by the states of consecutive spins, similar to a classical storage space. At this stage, it should be noted, however, that this partitioning of the space of states of the storage medium is the partitioning of a mathematical space which need not correspond to making a partitioning in physical three dimensional space. Although it can of course be provided that a certain group of nuclei or electrons forming the above-mentioned spin system are considered as that part of the physical storage medium where a certain record is to be stored, this is not a necessary feature of this example. For example, considering a storage medium consisting of two spin systems, each having two spin states, one may provide that one record space is the mathematical subspace of the storage space defined by the states of one spin system. However, one may as well define as one record space those states where the spin of the first system is up and the spin of the second system is either up or down and as the second record space the states where the first spin is down and the second spin is either up or down.

Let us assume that the sample sequence s to be found consists of residues to r₀ to rₘ₋₁. The database D to be searched is constructed from the domains of the human genome placed end-to-end so that a continuous list of N residues R₀, R₁,. . . , R_{N-1} is created. The task to be solved is to find a subsequence of m residues R, matching the sample sequence s. Each residue is labeled by a letter of the 20-letter amino acid alphabet so that each residue has to be represented by five bits B_{μν}. For the purpose of this discussion an example is considered where each record in the database comprises 5 m qubits representing the sequence Rᵢ plus an appropriate number of qubits providing an index labeling the various records. One may view this as a first register storing the proper sequence data and a second register storing the index thereof, the corresponding states of the first and second register being entangled with each other.

Using this kind of definition, the database is represented by a quantum superposition of quantum states as

$$\vert {Ψ}_{D} >= \frac{1}{\sqrt{N - m + 1}} {\sum }_{i = 0}^{N = m} \vert {Φ}_{i} > ⊗ \vert i >$$

wherein i labels all consecutive subsequences in the database of length m which may be represented by

$$\vert {Φ}_{i} >= {\prod }_{μ = i}^{i + m - 1} {\prod }_{v = 0}^{4} \vert {B}_{μ v} >= {\prod }_{a = 0}^{5 m - 1} \vert {q}_{i a} >$$

wherein |B_{μν}> represents the bits representing one residue R_{μ, q}ᵢₖ designating just the consecutive qubits of the record in another representation.

The number i of the subsequence |Φᵢ> stored in the second register defined by the states may be accessed by an operator \hat{X}, acting in the Hilbert space of the states |i>, which returns the sequence number as

\hat{X}|i>=i|i>.

The sample sequence can likewise be defined by a state

$$\vert s >= {\prod }_{a = 0}^{5 m - 1} \vert {s}_{α} >$$

A distance, e.g. the Hamming distance can be defined between two sequences. For a Hamming distance, one assigns a 1 to each position where the bits are different and 0 to every position where the bits are identical and finally sums up the ones and zeros. A distance operator

$$\hat{T} : \hat{T} \vert {ϕ}_{i} >= {T}_{i} \vert {ϕ}_{i} > with {T}_{i} = d ( s , {Φ}_{i} ) ,$$

can be defined, wherein Tᵢ is the Hamming distance between the query sequence s and the sequence represented by Φᵢ. φᵢ is defined by

$$\vert {ϕ}_{i} >= {\prod }_{a = 0}^{5 m - 1} \vert {p}_{i α} >$$

wherein |p_{iα}> is a qubit in a state corresponding to 0, if q_{iα}=s_{α} and 1, if q_{iα}≠s_{α}.

|Φᵢ> is related to |φᵢ> by the CNOT (Controlled NOT) operation. The CNOT operation has the following effect. If the qubit q_{iα} at position iα is in the same state as s_{α}, i.e. its value is identical to the corresponding bit in the query sequence, this qubit is put in a state indicating 0, Otherwise it is set to one. In other words, considering a spin system, the spin is set to down (down indicating 0), if there is a match at position α, and it is set to up (corresponding to 1), if there is no match.

The state |Ψ_{H}> defined by

$$\begin{matrix}\vert {Ψ}_{H} >= {U}_{C N O T} ( S ) ⊗ \underline{1} \vert {Ψ}_{D} > \\ = \frac{1}{\sqrt{N - m + 1}} {\sum }_{i = 0}^{N - m} \vert {ϕ}_{i} > ⊗ \vert i >\end{matrix}$$

is a state indicating for each index i the distance of the sequence initially stored at position i to the query sequence s.

Assuming now that there is exactly one match at position 1, 0≦1≦N−m one can write

$$\vert {Ψ}_{H} = \sqrt{\frac{N - m}{N - m + 1}} \vert R > + \frac{1}{\sqrt{N - m + 1}} \vert {ϕ}_{i} > ⊗ \vert 1 >$$

with

$$\vert R >= \frac{1}{\sqrt{N - m}} {\sum }_{i \neq 1} \vert {ϕ}_{i} > ⊗ \vert i >$$

One ran now apply the Grover algorithm. One defines an operator

I_{S}=1−|φᵢ><φᵢ|, with

|φᵢ>=|0000 , . . . , 0>

and a further operator I_{H} as

I_{H}=1−2|Ψ_{H}><Ψ_{H}|

I_{S} has the effect

$${I}_{S} \vert {ϕ}_{i} >= \{ \begin{matrix}- \vert {ϕ}_{i} > , if {T}_{i} = 0 \\ \vert {ϕ}_{i} > , if {T}_{i} \neq 0\end{matrix}$$

One can now define a unitary operator

U_{G}=−I_{H}I_{S}

U_{G} can be represented as

$${U}_{G} = ( \begin{matrix}cos θ & sin θ \\ - sin θ & cos θ\end{matrix} )$$

with

$$sin θ = \frac{2 \sqrt{N - m}}{N - m + 1}$$

After k steps the algorithm yields

|Ψₖ>=U^{k}|Ψ_{H}>=Σᵢcᵢ^{k}|φᵢ> [symbol] |i>

with cᵢ^{k} indicating the amplitude of respective wave function φᵢ.

cᵢ^{k}=cos(k/θ−α), (1)

with

$$cos α = \frac{1}{\sqrt{N - m + 1}}$$

As α is a positive number, the argument of the cos in formula (1) will come close to 0 after a certain number of iterations, thereby rendering the maximum value of |cᵢ^{k}|², ideally something close to 1. One now measures <Î>, which will in fact return the value for each index i, Tᵢ, with a probability of |cᵢ^{k}|² so that <Ψₖ|\hat{T}|Ψₖ>=ΣᵢTᵢ|cᵢ^{k}|². When a value

<\hat{T}>≈0

is found then the algorithm has succeeded and a subsequent measurement of \hat{X} in the second register will give the position 1 of the sequence in the database by virtue of

$$⟨ \hat{X} ⟩ = ⟨ {Ψ}_{k} \vert \hat{X} \vert {Ψ}_{k} ⟩ = {\sum }_{i = 0}^{N} \vert {c}_{i}^{k} {\vert}^{2} i \approx \vert {c}_{l}^{k} {\vert}^{2} 1$$

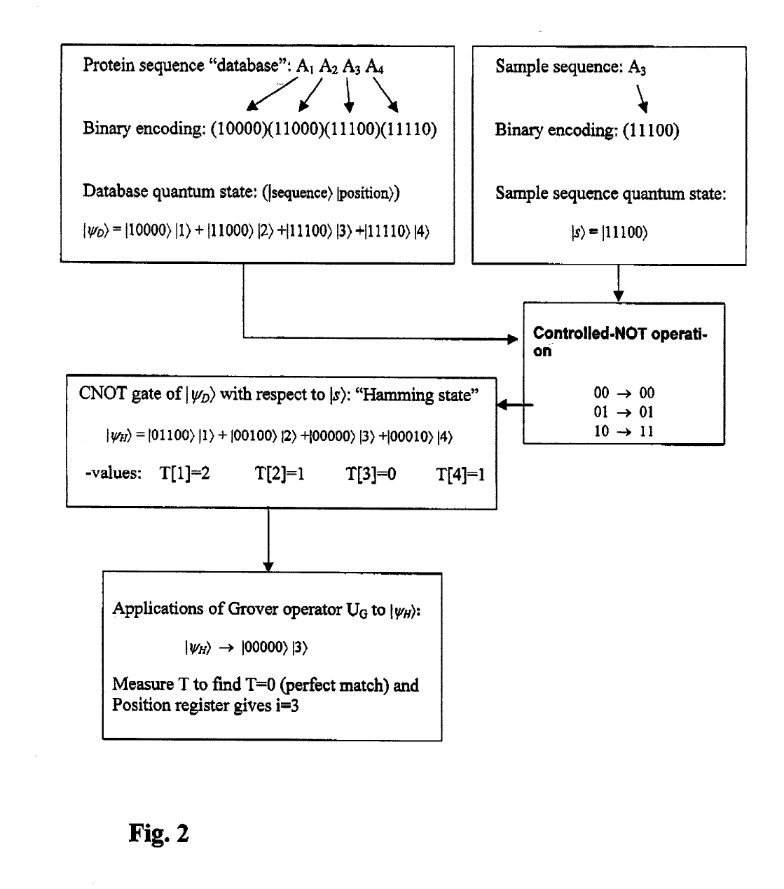

The process described above is schematically illustrated in FIG. 2 for a simple example. Of four possible sequences A₁ to A₄ one (A₃) is matching the sample sequence. Applying the CNOT operation by use of a CNOT gate yields a |Ψ_{H}>. The Grover operator U_{G} is applied to make |Ψ_{H}> essentially |00000> [symbol] |3>. This can be determined by measuring the value of the operator T. If <T> is found to be essentially 0, a measurement in the position register yields the value i=3 which is the number of the sequence initially contained in Ψ_{D} at position 3.

If there is more than one exact solution, one can use the algorithm of Boyer et al (M. Boyer et al., Fortscbr. Phys. 46 (1998), 493) adapted in a straightforward manner.

One problem encountered, however, in sequence matching is basically that the sample sequence may not be contained exactly in the database.

In this case one defines an operator

$${I}_{s} ( n ) : {I}_{s} ( n ) \vert {ϕ}_{i} = \{ \begin{matrix}- \vert {ϕ}_{i} > , {T}_{i} = n \\ \vert {ϕ}_{i} \vert > otherwise\end{matrix}$$

The algorithm is now iterated with iteration index n, given the case using the BPHT algorithm. A repeat index r is defined as a predetermined measure of the search confidence level.

The iteration runs as follows. In the first iteration one searches for the occurrence of a state with zero Hamming distance (Tᵢ=0, n=0). If this is successful, the position is measured and the process exits. If this is unsuccessful after repeating the BPHT algorithm r times, one proceeds to the next iteration. The n+1st iteration searches for a state where Tᵢ=n with

U=−I_{H}I_{S}(n).

If this is successful, one locates the position of the qubits and exits. Otherwise one proceeds to the next iteration using I_{S}(n+1). If n exceeds a certain limit, the process terminates.

It will be apparent to a person skilled in the art that other variants of the general method out-lined above or of the specific method described with regard to an example which are obvious to those skilled in the art and other, similar approaches for finding optimal matches in data-bases can be applied without departing from the scope of the present invention, Especially other similarity measures for genetic databases and/or other algorithms than those explicitly described may be used.

The features of the invention disclosed in this specification, the claims and/or the drawings can be material for the realization of the invention both taken alone and in any combination thereof.

1. Use of a quantum computer for storing one or more databases comprising a plurality of records and searching one or more databases for a record matching a query record.

2. Use of a quantum computer according to claim 1 comprising the step of searching for a record similar or identical to a query record.

3. Use of a quantum computer according to claim 1, wherein a database comprises biological data.

4. Use according to claim 3, wherein a database comprises genetic data.

5. Use according to claim 4, wherein a query comprises a genetic sequence or a partial genetic sequence.

6. Use according to claim 4, wherein said databases include genetic patterns.

7. Use according to claim 5, wherein said databases include three-dimensional structure of proteins and/or other macromolecules.

8. Use according to claim 3, wherein a query comprises a genetic sequence and said record to be matched comprises a sequence family.

9. Use according to claim 3, wherein said query record comprises a genetic sequence and said record to be matched comprises the structure of a macromolecule or a structural family of macromolecules.

10. Use according to claim 3, wherein a query comprises a structure of a macromolecule and said record to be matched comprises a structure of a macromolecule or a structural family of macromolecules.

11. Method of performing a search in a database according to a given query, wherein said database is stored on a quantum computer having a storage medium able to assume a plurality of quantum states, said quantum states corresponding to a basis of a storage space, said storage space being a finite or infinite vector space,
said quantum computer further comprising means for physically interacting with said storage medium such that the state thereof changes according to a predetermined operation, wherein the records in said database are implemented as record states forming quantum states in said storage space and the database to be interrogated is implemented as a database state of said storage medium, said database state forming a linear combination of the related record states, said method comprising the steps of:
defining a query state as a quantum state of said storage space,
defining a global evaluation state as a linear combination of basic evaluation states, said basic evaluation states having a one-to-one relation to the record states forming the database state,
defining an evolving operator, depending on the query and the data stored as records, such that the application of said evolving operator on said global evaluation state enhances the amplitude of a basic evaluation state corresponding to a data state matching the query state,
establishing said global evaluation state in said storage medium,
providing a physical interaction of said interacting means with the part of said storage medium being in the global evaluation state corresponding to said evolving operator,
determining the state or the states of which the amplitude was enhanced, and determining the records corresponding to these states.

12. Method according to claim 11, wherein said evolving operator is a unitary operator.

13. Method according to claim 11, wherein said interacting means apply a magnetic and/or electric field to said storage medium.

14. Method according to claim 11, characterized in that said evolving operator leaves the space spanned by the basic evaluation states invariant.

15. Method according to claim 11, wherein said evolving operator depends on a distance function defined between the query state and the individual record states.

16. Method according to claim 15, wherein said distance function is defined through a distance operator acting on the space spanned by said basic evaluation states, said distance operator leaving said basic evaluation states invariant.

17. Method according to claim 16, wherein said data states are eigenstates of said distance operator.

18. Method according to claim 15, wherein said distance function is a Hamming distance.

19. Method according to claim 15, wherein said basic evaluation states comprise qubits indicating said distance of the related record to the query state.

20. Method according to claim 19, wherein said basic evaluation states comprise qubits forming an index relating the basic evaluation states to the record states.

21. Method according to claim 16, wherein said basic evaluation states are related to said record states by a CNOT operation depending on the query state.

22. Method according to claim 18, wherein said query state, said record states and said basic evaluation states are defined by qubits, said basic evaluation states comprise qubits having a state coresponding to 1, if the state of the corresponding qubit of the record state is not identical to the state of a corresponding qubit of the query state, and having a state coresponding to 0, if the state of the corresponding qubit of the record state is identical to the state of a corrseponding qubit of the query state.

23. Method according to claim 11, wherein said global evaluation state is identical to the database state.

24. Method according to claim 11, wherein said evolving operator is identical to or a function of an operator U_{G}, said operator being defined by
U_{G}=−I_{H}I_{S}, wherein
I_{H}=1−|Ψ_{H}><Ψ_{H}|,
Ψ_{H} being the global evaluation state and wherein I_{S} is defined such that
I_{S}|φᵢ>=−|φᵢ>, if Tᵢ is less than a predetermined value,
I_{S}|φᵢ>=|φᵢ> otherwise,
wherein |φᵢ> denotes one of said basic evaluation states and Tᵢ is the distance between the query state and the record state corresponding to |φᵢ>.

25. Method according to claim 24, wherein said predetermined value of said distance is essentially 0.

26. Method according to claim 11, comprising the step of determining whether the amplitude of one or more basic evaluation states was enhanced to a value close to or equal 1.

27. Method according to claim 16, comprising the step of determining whether the value of the distance m said state resulting from applying said evolving operator on said global evaluation state is less than a predetermined value.

28. Method according to claim 27, comprising the step of determining whether the value of the distance in said state resulting from applying said evolving operator is essentially zero.

29. Method according to claim 24, wherein in a first iteration a first value of said distance for comparing Tᵢ in the definition of I_{S} is given a first value and it is determined whether the value of the distance in said state resulting from applying said evolving operator is less than said first value, and in a subsequent iteration a second value of said distance for comparing Tᵢ in the definition of I_{S} is determined, said second value being greater than said first value and it is determined whether the value of the distance in said state resulting from applying said evolving operator is less than said second value.

30. Quantum computer having a storage medium able to assume a plurality of quantum states, said quantum states corresponding to a basis of a storage space, said storage space being a finite or infinite vector space, said quantum computer further comprising means for physically interacting with said storage medium such that the state thereof changes according to a predetermined operation, wherein a database is stored on said storage medium, wherein the records in said database are implemented as record states forming quantum states in said storage space and the database to be interrogated is implemented as a database state of said storage medium, said database state forming a linear combination of the related record states, wherein a query state is defined as a quantum state of said storage space, a global evaluation state is defined as a linear combination of basic evaluation states, said basic evaluation states having a one-to-one relation to the record states forming the database state, an evolving operator, depending on the query and the data stored as records, is defined such that the application of said evolving operator on said global evaluation state enhances the amplitude of a basic evaluation state corresponding to a data state matching the query state, and said global evaluation state is established in said storage medium, said quantum computer performing the following steps:
providing a physical interaction of said interacting means with the part of said storage medium being in the global evaluation state corresponding to said evolving operator,
determining the state or the states of which the amplitude was enhanced, and determining the records corresponding to these states.
